(19) United States
(12) Patent Application Publication
(10) Pub. No.: US 2005/0102367 A1
(43) Pub. Date: May 12, 2005

(54) Process for writing e-mail and text on portable devises and a simplified key board with multi-dimensional switches for this process

(76) Inventor: Frank W. Johnson, Beulah, MI (US)

Correspondence Address: Frank W. Johnson, 5785 Van Deman Pl., PBO 229, Beulah, MI, 49617, US

(21) Appl. No.: 10/705,089

(22) Filed: Nov. 12, 2003

(51) Int. Cl. G06F 15/16

(52) U.S. Cl. 709/207

(57) ABSTRACT

A word processing system where you send voice dictation to the base station and it is turned into text by the base station voice to text system. The text is returned to the portable communication devise for final editing and then sent to the addressee. The second part of this patent is a simplified, multi-directional, small, keyboard utilizing either forward or back keys or forward, back, left, and right keys. You can also add the usual key movement of down, for a fifth motion. In this way you have enough key motions to record as many of the characters as you want, though you may need several simultaneous key strokes.

### CROSS-REFERENCES TO RELATED APPLICATIONS

U.S. PATENT DOCUMENTS

| | | | |
|---|---|---|---|
| #6,219,694 | Apr. 17, 2001 | Lasaridis, et al | 709/206 |
| #6,563,061 | May 13, 2003 | Takahashi | 205/5 A; 200/343 |

### BACKGROUND OF THE INVENTION

The field of endeavor of this invention is writing e-mail and other text on portable (and small) communication devises and the key boards they have. My invention covers two processes for this. Remote e-mail is done in a variety of ways. Blackberry of RIM corporation of Canada has recently received a patent for their remote e-mail process and filed suits against perceived infractions of this patent (U.S. Pat. No. 6,219,694). The keyboard patents are numerous, involve many layouts, and features. The one that is closest too my patent is U.S. Pat. No. 6,563,061. This patent is for a rocker switch which enable you to send two different signal from one point of entry. Other devises use repeated signal on the same keypad for multiple outputs from one entry point.

1^{st}. If you have voice communication you can use the voice to the base station as a dictation process. You dictate into the portable devise. This voice dictation is transferred to the base station. At the base station you have a large complex and effective voice to text translation system. You then return the text to the portable devise for corrections, and send it out via the text part of your communication devise as e-mail or other text. By using the superior processing power at the base station, you have both superior processing power and a smaller portable communication devise.

### DETAILED DESCRIPTION OF THE INVENTION

### An E-male and a Word Processing System

1^{st} .This invention requires your remote devise to have both voice and text communication ability. You dictate into the portable devise in the voice mode. This is transferred to the base station in the voice mode. At the base station you have a large complex and effective voice to text translation system. You then return the text for correction, and which sends it out via the text part of your communication devise as e-mail or other text.

By using the superior processing power at the base station, you have both superior processing power and a smaller communication devise. This is because it is impossible with current technology to add a good voice to text translator with its large processor, high power requirement to a portable device, and it is very difficult to have an adequate keyboard for text in a small devise. Styluses get lost and key by key switching, is compared to a full sized keyboard, slow and awkward.

2^{nd}. The keyboard required for revising text is much more specialized and limited than a full text keyboard you would require for filing full text messages.

### Simplified Key Board with Multi-Directional Switches

I have invented a more compact and versatile key board for both text and revising text. Each key has a small knob on the keyboard end that is easily identified by touch and is far enough from the next keyboard knob so that in pushing one knob you will not push the other. The shaft will activate a switch in either 2 (forward and back) or four (forward, back, left, and right) directions. It may also be activated by pushing in five directions (forward, back, left, right, and in)

The four fingers can push up, push down, and depress well. Sidewise motion is difficult for the fingers. The thumb on both the writing hand, and the holding hand can function in all five ways. Out of this you build a steno pad type of keyboard, with maximum efficiency but harder to learn, or a text pad where you depress several keys at once.

You can do this phonetically, or letter by letter. The best, or several, embodiments can be developed by experts in their field and need not be included in the patent, as they are maters of design and not fundamental to the idea of multiple directional switches.

The shafts with the knobs may be anchored and pivoted either at the surface, with the switches below or at the base with the switches between the pivot and the surface. These again are questions of design and not fundamental to this switching process.

1 A word processing system for e-mail and other text that has
a. a remote, usually mobile input system, and
b. a base station that is usually fixed, and has higher processing power than the remote input, and
c. the remote devise is used for dictating, and the base station is used to convert the voice to text by a sophisticated voice-text system, and
d. the signal may be sent out to its destination or returned to the remote devise, and corrected, and then sent out to the recipient, and
e. the remote base devise performs other tasks, such as storage, classification, of the messages and other instruction, etc., and

2 A keyboard, with multi-directional switches, that is an input devise where each key has
a. knob that is easily identified by touch, and
b. is usually far enough from the next knob so that pushing one knob will not engage its neighbor, and
c. the shaft will activate a switch in either 2 (forward and back) or 4 (forward, back, left, or right) directions, and
d. it may also be activated by also by pushing in for a total of 5 alternatives, and
e. the key may be on the side of the pad or either/or the holding hand or the keying hand, and
f. The shafts with the knobs may be anchored and pivoted either at the surface, with the switches below or at the base with the switches between the pivot and the surface. These again are questions of design and not fundamental to this switching process.
